(19) United States
(12) Patent Application Publication
(10) Pub. No.: US 2001/0022874 A1
(43) Pub. Date: Sep. 20, 2001

(54) Optical gain equalizer and optical gain equalizing method

(76) Inventor: Shohei Yamaguchi, Tokyo (JP)

Correspondence Address: McGinn & Gibb, PLLC, 8321 Old Courthouse Road, Suite 200, Vienna, VA, 22182-3817, US

(21) Appl. No.: 09/805,173

(22) Filed: Mar. 14, 2001

(30) Foreign Application Priority Data
Mar. 15, 2000 (JP) 72045/2000

(51) Int. Cl. G02B 6/26

(52) U.S. Cl. 385/15

(57) ABSTRACT

An optical gain equalizer is provided with an erbium doped optical fiber (EDF). The gain equalizer selects two lights out of wavelength division multiplexed light, controls pumping light to EDF based upon the result of the comparison of the levels and flattens the inclination of the gain of the wavelength division multiplexed light. Another optical gain equalizer is provided with EDF and a variable attenuator. The optical gain equalizer selects two lights out of wavelength division multiplexed light and attenuates the wavelength division multiplexed light based upon the result of comparing the levels of the two lights. The power of pumping light to EDF that amplifies wavelength division multiplexed light is controlled based upon this attenuation and the inclination of the gain of the wavelength division multiplexed light is flattened.

### BACKGROUND OF THE INVENTION

1. Field of the Invention

The present invention relates to an optical gain equalizer and an optical gain equalizing method, particularly relates to an optical gain equalizer and an optical gain equalizing method for controlling the inclination of the gain of wavelength division multiplexed light in a wavelength division multiplex (hereinafter called WDM) optical transmission system.

2. Description of the Related Prior Art

In a WDM optical transmission system, wavelength division multiplexed light transmitted on an optical fiber transmission line gradually attenuates. Therefore, an optical repeater installed at a predetermined interval on the optical fiber transmission line amplifies the wavelength division multiplexed light. However, loss on an optical fiber transmission line, amplification by an optical repeater and Raman amplification caused on the input side of the optical repeater depends upon a wavelength. Therefore, the gain of wavelength division multiplexed light transmitted on an optical fiber transmission line has predetermined inclination for a wavelength. As the system does not operate when the inclination of the gain exceeds a fixed value, an optical fiber transmission line is provided with a block optical gain equalizer at a predetermined interval to level the gain of wavelength division multiplexed light.

A conventional type block optical gain equalizer branches wavelength division multiplexed light, selects light having a specific wavelength out of branched light, converts this light to electric information and controls a variable gain equalizer based upon the electric information. However, this variable gain equalizer cannot detect the inclination of the gain of wavelength division multiplexed light. Therefore, a receiving station detects the inclination of the gain and transmits the detected information to a transmitting station so that the inclination of the gain is controlled. That is, the block gain equalizer cannot execute automatic control. Also, as the equalizer itself attenuates wavelength division multiplexed light, an interval of an optical transmission line at which the block optical gain equalizer is installed is required to be shortened, compared with an interval of another repeater.

### SUMMARY OF THE INVENTION

Therefore, the object of the invention is to provide an optical gain equalizer and a gain equalizing method wherein the inclination of the gain of wavelength division multiplexed light can be automatically controlled and no loss is assigned to the light.

To achieve the object, the optical gain equalizer is provided with an optical fiber amplification medium that amplifies wavelength division multiplexed light, an optical directional coupler that branches amplified wavelength division multiplexed light, a filter that selects first light and second light out of branched light and a control circuit that controls the optical fiber amplification medium based upon difference in a level between the first and second lights. The control circuit is provided with optical receivers that respectively convert the first and second lights to electric information, a comparator that compares these electric information and a pumping light source that sends pumping light to the optical fiber amplification medium based upon the output of the comparator. The control circuit can be also provided with a driving control circuit that controls the pumping light source based upon the output of the comparator.

Another optical gain equalizer is provided with an optical fiber amplification medium that amplifies wavelength division multiplexed light, an optical directional coupler that branches amplified wavelength division multiplexed light, a control circuit that controls the optical fiber amplification medium based upon branched light, a variable optical attenuator that attenuates the wavelength division multiplexed light, filters that respectively select first light and second light out of the branched light and control means that controls the variable optical attenuator based upon difference in a level between the first and second lights. The control means is provided with optical receivers that respectively convert the first and second lights to electric information and a comparator that compares these electric information. The control means can be also provided with a control circuit that controls the variable optical attenuator based upon the output of the comparator. The variable optical attenuator can be installed on the input side or on the output side of the optical fiber amplification medium.

A gain equalizing method includes a step for selecting two lights having different wavelengths out of wavelength division multiplexed light, a step for comparing the two lights and a step for controlling excited light to the optical fiber amplification medium that amplifies the wavelength division multiplexed light based upon the result of the comparison and controlling the inclination of the gain of the wavelength division multiplexed light.

Another gain equalizing method includes a step for selecting two lights having different wavelengths out of wavelength division multiplexed light, a step for comparing the two lights, a step for attenuating the wavelength division multiplexed light based upon the result of the comparison and a step for controlling excited light to the optical fiber amplification medium based upon the attenuated wavelength division multiplexed light and controlling the inclination of the gain of the wavelength division multiplexed light. By this method, attenuated wavelength division multiplexed light can be input to the optical fiber amplification medium or wavelength division multiplexed light amplified by the optical fiber amplification medium can be attenuated.

According to the invention described above, the gain of wavelength division multiplexed light is automatically controlled and flattened. Also, no loss is applied to wavelength division multiplexed light.

### BRIEF DESCRIPTION OF THE DRAWINGS

The above and other objects, features and advantages of the present invention will become apparent from the following detailed description when taken with the accompanying drawings in which:

FIG. 1 is a block diagram showing a WDM optical fiber transmission line for transmitting wavelength division multiplexed light;

FIG. 2 is a block diagram showing a conventional type optical gain equalizer;

FIG. 3 is a block diagram showing a concrete example of an optical gain equalizer;

FIGS. 4A and 4B are graphs showing the characteristic of an optical fiber amplification medium (an erbium doped optical fiber amplifier (EDFA));

FIG. 5 is a block diagram showing a second concrete example of the optical gain equalizer;

FIG. 6 is a block diagram showing a third concrete example of the optical gain equalizer;

FIG. 7 is a block diagram showing a concrete example of an optical gain equalizer provided with a variable attenuator;

FIG. 8 is a block diagram showing a second concrete example of the optical gain equalizer provided with the variable attenuator;

FIG. 9 is a block diagram showing a third concrete example of the optical gain equalizer provided with the variable attenuator;

FIG. 10 is a block diagram showing a fourth concrete example of the optical gain equalizer provided with the variable attenuator;

FIG. 11 is a block diagram showing a fifth concrete example of the optical gain equalizer provided with the variable attenuator; and

FIG. 12 is a block diagram showing a sixth concrete example of the optical gain equalizer provided with the variable attenuator.

### DETAILED DESCRIPTION OF THE PREFERRED EMBODIMENTS

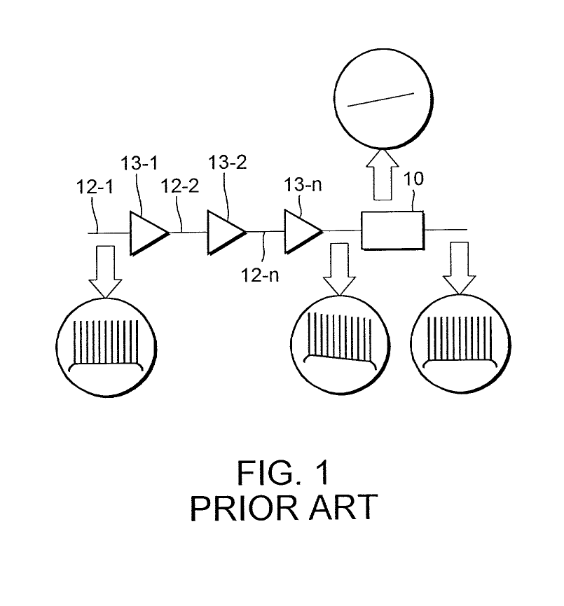

FIG. 1 shows a WDM optical fiber transmission line provided with optical repeaters 13-1 to 13-n and an optical gain equalizer 10. The inclination of the gain shown in FIG. 1 is applied to wavelength division multiplexed light by optical fibers 12-1 to 12-n and the optical repeaters 13-1 to 13-n. The optical gain equalizer 10 is provided with a characteristic that compensates the inclination of the gain of the wavelength division multiplexed light. Therefore, the gain of wavelength division multiplexed light output from the optical gain equalizer 10 is flat. A WDM optical fiber transmission line is provided with such an optical gain equalizer 10 every predetermined interval.

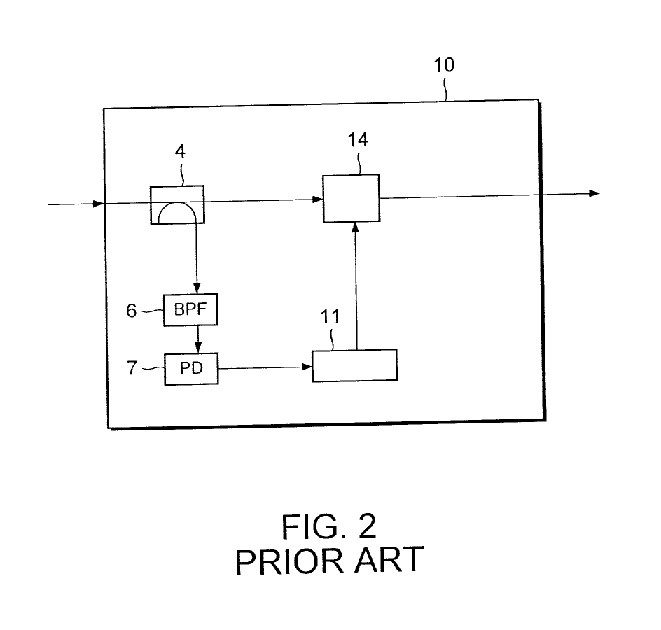

Referring to FIG. 2, a conventional type block optical gain equalizer 10 is provided with a coupler 4 and a variable gain equalizer 14. A band-pass filer (BPF) 6 selects light having a predetermined wavelength out of wavelength division multiplexed light branched from the coupler 4 and a photodiode (PD) 7 converts this light to electric information. This electric information is supplied to a control circuit 11 that controls the variable gain equalizer 14. However, the block optical gain equalizer 10 cannot detect the inclination of the gain of wavelength division multiplexed light. Therefore, a receiving station that receives the wavelength division multiplexed light detects the inclination of the gain and the gain is equalized according to a control signal based upon the result of the detection.

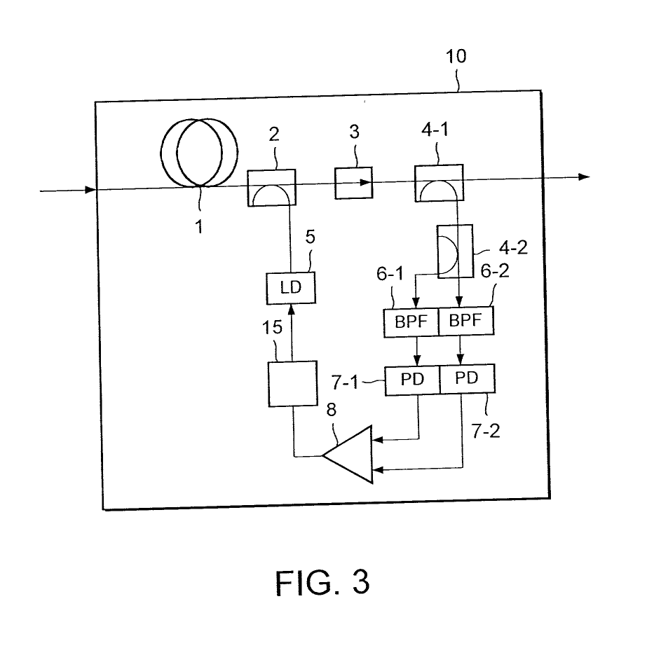

Referring to FIG. 3, an optical gain equalizer 10 according to the invention is provided with an erbium doped optical fiber (EDF) 1, a WDM coupler 2, an isolator 3 and a photocoupler 4-1 respectively concatenated. A photocoupler 4-2 is connected to the photocoupler 4-1 and band-pass filters (BPF) 6-1 and 6-2 are connected to the photocoupler 4-2. Photodiodes (PD) 7-1 and 7-2 are respectively connected to BPFs 6-1 and 6-2. The output of PDs 7-1 and 7-2 is input to a comparator 8. A pumping light source control circuit 15 receives the output of the comparator 8 and controls a laser diode (LD) 5 which is the pumping light source. Pumping light is input to EDF1 via the WDM coupler 2.

The operation of the optical gain equalizer 10 is as follows. Wavelength division multiplexed light transmitted on the optical fiber transmission line is incident on EDF 1, is amplified and is branched by the photocoupler 4-1. One of two branched lights by the photocoupler 4-1 propagates on the optical fiber transmission line as it is. The other branched light is further incident on the photocoupler 4-2 and is branched. BPFs 6-1 and 6-2 respectively select light having a predetermined wavelength (λSV1, λSV2) out of each branched light. It is desirable that these two wavelengths are the shortest wavelength and the longest wavelength of signal lights included in wavelength division multiplexed light. However, other lights different in a wavelength may be also selected. PDs 7-1 and 7-2 convert these two selected lights to each electric information (each voltage value) and the comparator 8 compares these voltage values. The pumping light source control circuit 15 controls LD 5 based upon the output of the comparator 8. LD 5 sends pumping light to EDF 1 via the WDM coupler 2 according to the control. The control can be performed so that difference between the voltage values (that is, levels of light) is fixed. No pumping light source control circuit 15 can be provided and the output of the comparator 8 can be also directly sent to LD 5.

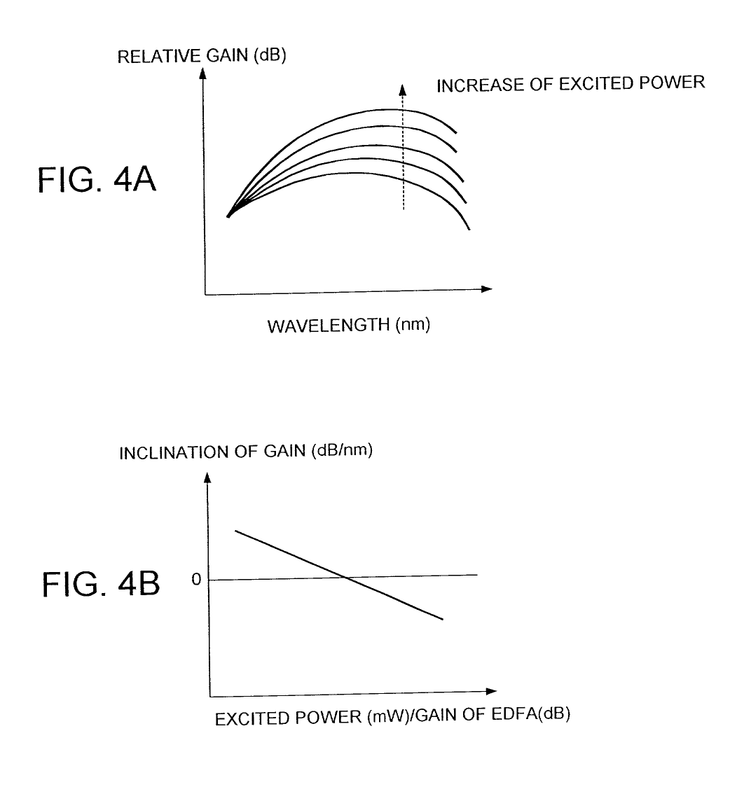

The gain of EDF 1 is controlled by pumping light and as a result, the inclination of the gain of EDF 1 is controlled. The reason is as follows. FIG. 4A is a graph showing relationship between the relative gain of EDF and a wavelength. The relative gain has a maximum value at a specific wavelength. At this time, when the power of pumping light is increased, the relative gain increases. Relationship between the inclination of the gain (dB/nm) and the power (mW) of pumping light/the gain (dB) of EDF is shown in a graph in FIG. 4B. That is, FIG. 4B shows that when the power of pumping light varies, the inclination of the gain of EDF substantially linearly varies. Therefore, the optical gain equalizer shown in FIG. 3 selects two lights having different wavelengths out of wavelength division multiplexed light, acquires difference in a level, that is, the inclination of the gain of wavelength division multiplexed light with the comparator 8, controls the power of pumping light in EDF and compensates the inclination of the gain. As the optical gain equalizer itself can detect the inclination of the gain of wavelength division multiplexed light and can automatically control it, the compensating operation requires no control signal from an external device.

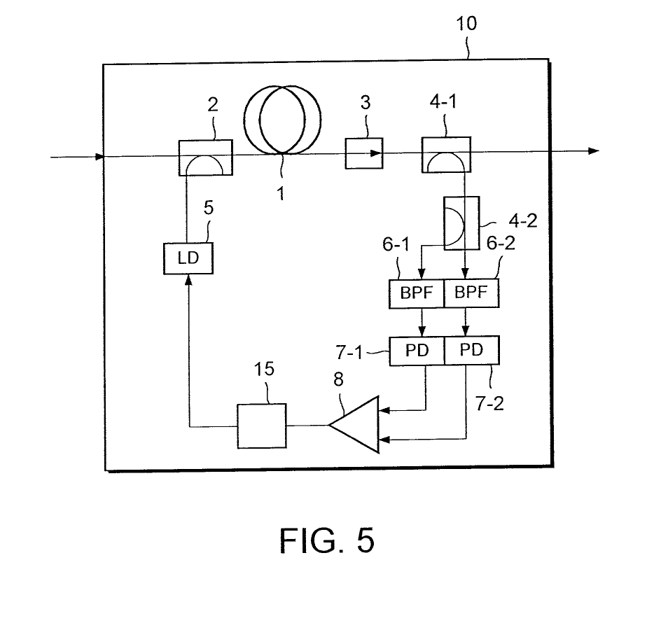

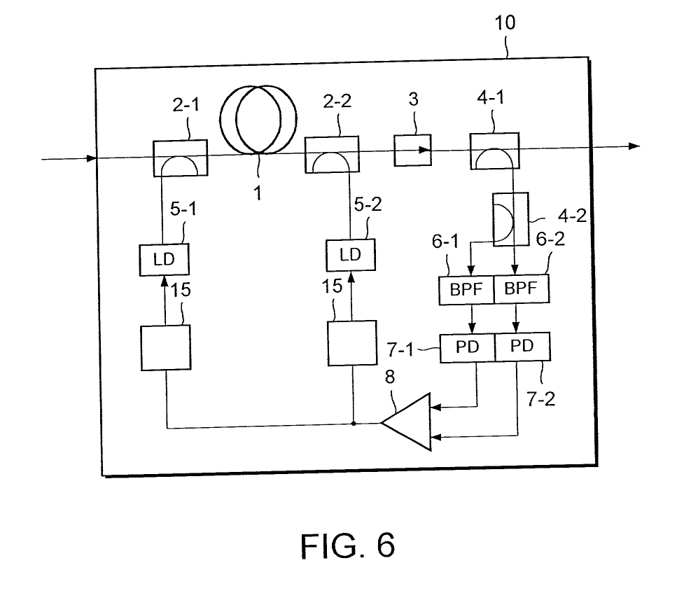

FIGS. 5 and 6 show concrete examples related to the optical gain equalizer shown in FIG. 3. In the optical gain equalizer shown in FIG. 3, excited light is incident on EDF 1 from the output side of EDF 1 via the WDM coupler 2. In optical gain equalizers shown in FIGS. 5 and 6, pumping light is respectively incident on EDF 1 from the input side of EDF 1 and from both the input side and the output side.

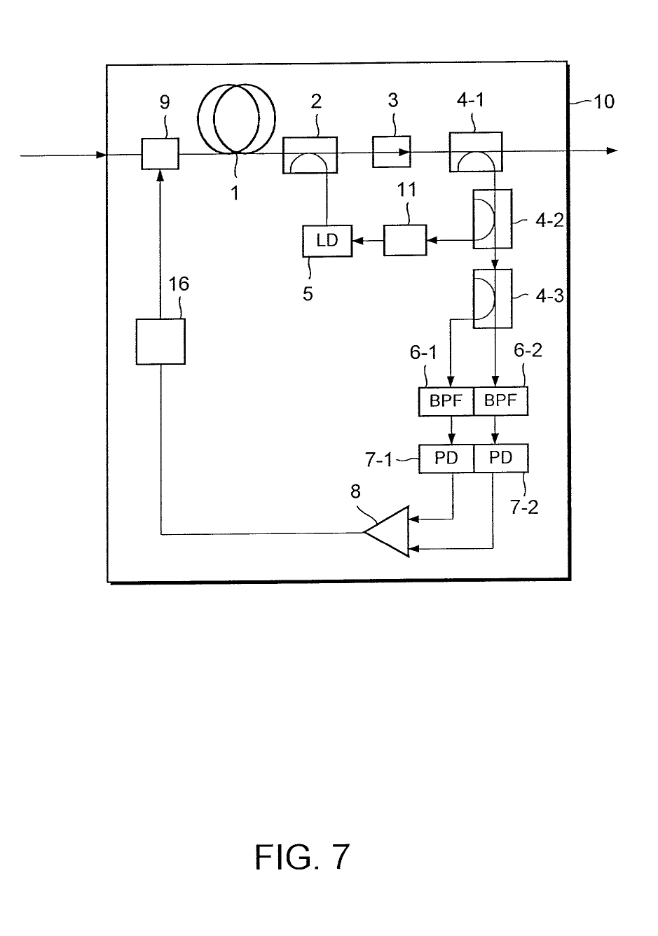

Referring to FIG. 7, an optical gain equalizer equivalent to another embodiment of the invention is provided with a variable attenuator 9, an erbium doped optical fiber (EDF) 1, a WDM coupler 2, an isolator 3 and a photocoupler 4-1 respectively concatenated from the input side. A photocoupler 4-2 to which one branched light is input is connected to the photocoupler 4-1. A control circuit 11 and a photocoupler 4-3 are connected to the photocoupler 4-2. The control circuit 11 controls LD 5 and sends pumping light to EDF 1 via the WDM coupler 2. BPFs 6-1 and 6-2 are connected to the photocoupler 4-3. PDs 7-1 and 7-2 are respectively connected to BPFs 6-1 and 6-2. Each output of PDs 7-1 and 7-2 is input to a comparator 8. A variable attenuator control circuit 16 that controls the variable attenuator 9 is connected to the comparator 8.

The operation of the optical gain equalizer 10 shown in FIG. 7 is as follows. The photocoupler 4-1 branches wavelength division multiplexed light and sends one branched light to the photocoupler 4-2. The photocoupler 4-2 further sends the branched light to the control circuit 11 and the photocoupler 4-3. The control circuit 11 controls the power of pumping light output by LD 5 based upon the level of input branched light and controls the gain of EDF 1. BPFs 6-1 and 6-2 respectively select light having a predetermined wavelength (λSV1, λSV2) out of each branched light from the photocoupler 4-3. It is desirable that these two wavelengths are the shortest wavelength and the longest wavelength of signal lights included in wavelength division multiplexed light. However, light having other wavelength may be also selected. PDs 7-1 and 7-2 respectively convert these two selected lights to electric information (a voltage value) and the comparator 8 compares these voltage values. The variable attenuator control circuit 16 controls the variable attenuator 9 and lowers the level of wavelength division multiplexed light incident on EDF1. At this time, EDF1 enhances the power of excited light and increases the gain corresponding to the lowering of the level of incident light. Therefore, the inclination of the gain of wavelength division multiplexed light varies according to the variation of the power of excited light and the gain can be flattened.

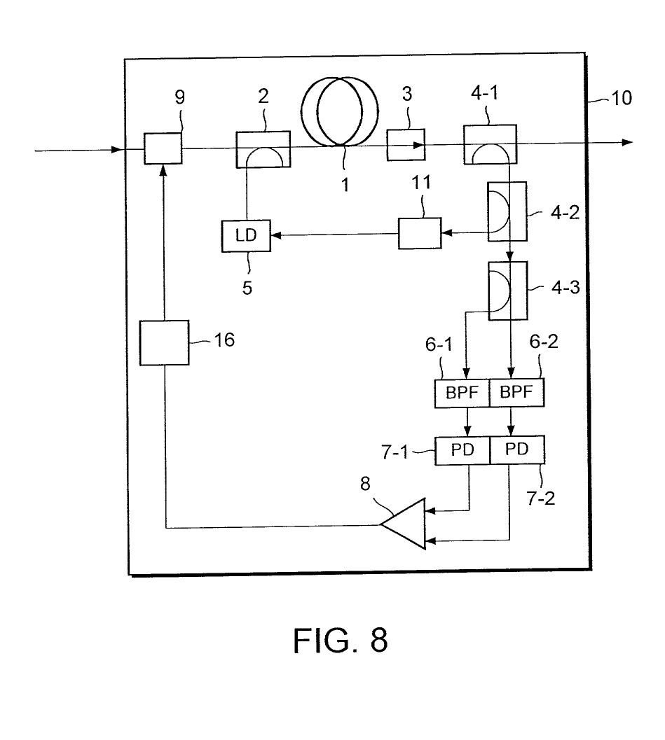

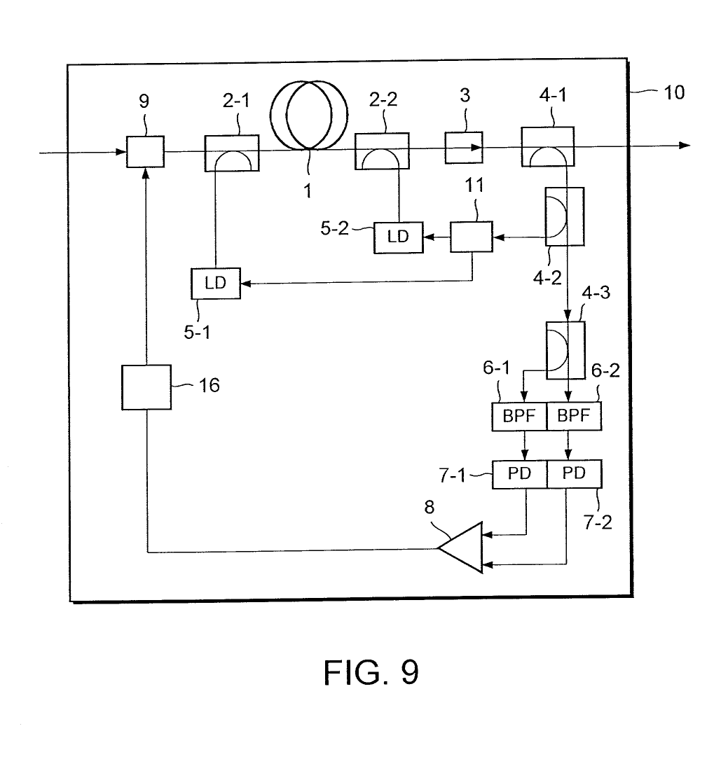

FIGS. 8 and 9 show concrete examples related to the optical gain equalizer 10 shown in FIG. 7. In the optical gain equalizer shown in FIG. 7, excited light is incident on EDF 1 from the output side of EDF 1 via the WDM coupler 2. In optical gain equalizers shown in FIGS. 8 and 9, excited light is respectively incident on EDF 1 from the input side of EDF 1 and from both the input side and the output side.

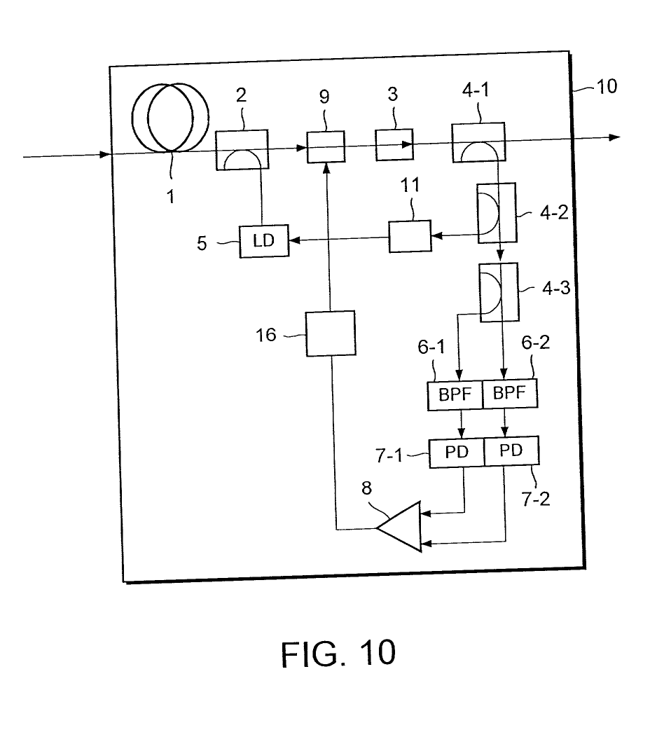

FIG. 10 shows another concrete example of the optical gain equalizer. An optical gain equalizer 10 shown in FIG. 10 has the same basic configuration as that of the optical gain equalizer shown in FIG. 7. However, a variable attenuator 9 is installed on the output side of EDF 1. Therefore, attenuated wavelength division multiplexed light is sent to a control circuit 11 that controls LD 5. Therefore, the control circuit 11 controls LD 5 and enhances the power of excited light sent to EDF 1. As a result, the inclination of the gain of wavelength division multiplexed light varies and the gain can be flattened.

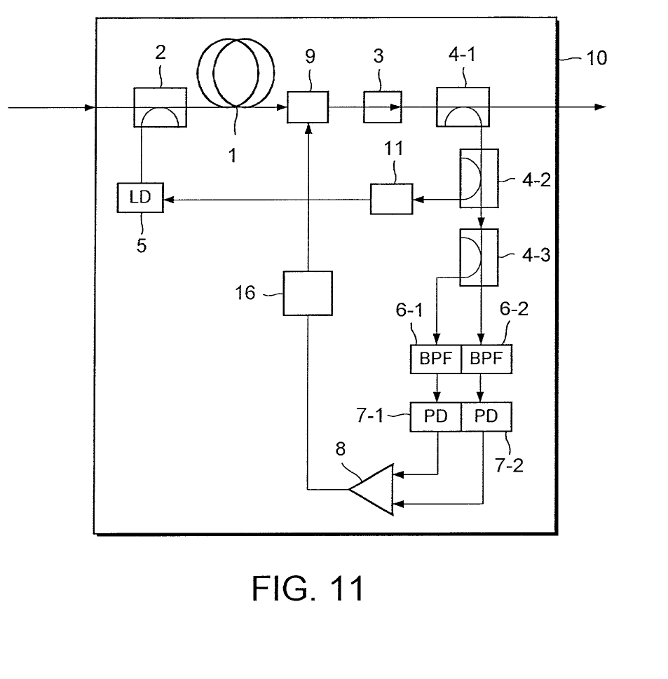

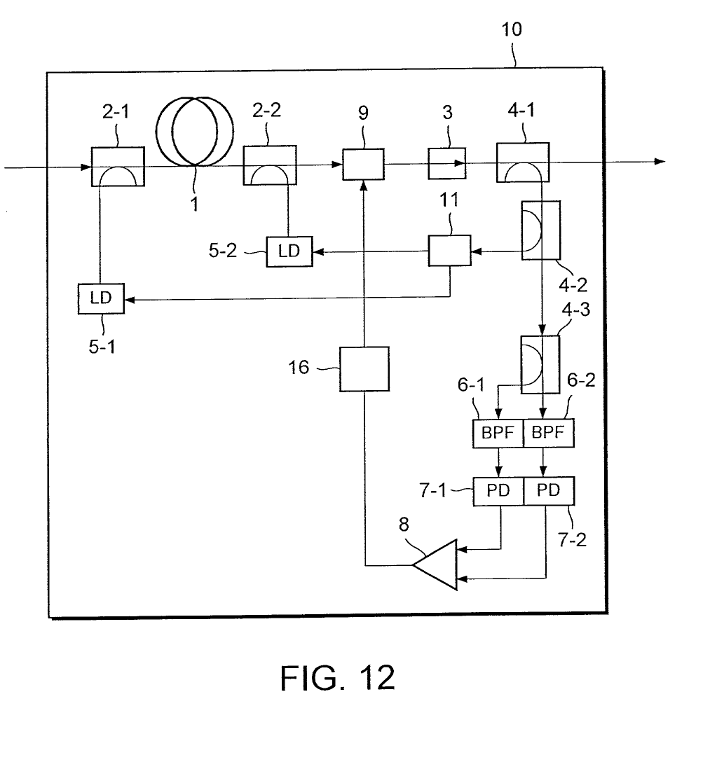

Optical gain equalizers shown in FIGS. 11 and 12 have the same basic configuration as that of the optical gain equalizer shown in FIG. 10. However, in these optical gain equalizers, pumping light is respectively incident on EDF 1 from the input side of EDF 1 and from both the input side and the output side.

Wavelength division multiplexed light which the optical gain equalizer according to the invention processes is light in a band of 1.55 μm for example. The components of the optical gain equalizer are all well known parts.

The optical gain equalizer and the gain equalizing method according to the invention can amplify wavelength division multiplexed light without control from an external device and can flatten the inclination of the gain. Therefore, an interval at which the optical gain equalizers are installed can be extended on the optical fiber transmission line.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. An optical gain equalizer that controls the gain wavelength characteristic of wavelength division multiplexed light, comprising:
an optical fiber amplification medium that amplifies wavelength division multiplexed light;
an optical directional coupler that branches amplified wavelength division multiplexed light;
a filter that selects first light and second light out of branched light; and
a control circuit that controls the optical fiber amplification medium based upon difference in a level between the first and second lights.

2. An optical gain equalizer that controls the gain wavelength characteristic of wavelength division multiplexed light, comprising:
an optical fiber amplification medium that amplifies wavelength division multiplexed light;
an optical directional coupler that branches amplified wavelength division multiplexed light;
a filter that selects first light and second light out of branched light; and
a control circuit that controls the optical fiber amplification medium based upon difference in a level between the first and second lights, wherein:
said control circuit comprises:
an optical receiver that respectively converts the first and second lights to electric information;
a comparator that compares these electric information; and
a pumping light source that sends pumping light to said optical fiber amplification medium based upon the output of the comparator.

3. An optical gain equalizer according to claim 2, wherein:
said control circuit comprises a pumping light source control circuit that controls a pumping light source based upon the output of the comparator.

4. An optical gain equalizer according to claim 2, wherein:
pumping light is input from at least one of the input side and the output side of an optical fiber amplification medium.

5. An optical gain equalizer according to claim 2, wherein:
first and second lights respectively have different wavelength from each other.

6. An optical gain equalizer according to claim 2, wherein:
first and second lights respectively have the shortest wavelength and the longest wavelength out of signal light included in wavelength division multiplexed light.

7. An optical gain equalizer that controls the gain wavelength characteristic of wavelength division multiplexed light, comprising:
an optical fiber amplification medium that amplifies wavelength division multiplexed light;
an optical directional coupler that branches amplified wavelength division multiplexed light;
a control circuit that controls the optical fiber amplification medium based upon branched light;
a variable optical attenuator that attenuates wavelength division multiplexed light;
a filter that selects first and second lights out of branched light; and
control means that controls the variable optical attenuator based upon difference in a level between the first and second lights.

8. An optical gain equalizer according to claim 6, wherein:
said control means comprises:
an optical receiver that respectively converts first and second lights to electric information; and
a comparator that compares these electric information.

9. An optical gain equalizer according to claim 7, wherein:
said control means comprises a control circuit that controls said variable optical attenuator based upon the output of the comparator.

10. An optical gain equalizer according to claim 6, wherein:
pumping light is input from at least one of the input side and the output side of the optical fiber amplification medium.

11. An optical gain equalizer according to claim 6, wherein:
first and second lights respectively have different wavelength from each other.

12. An optical gain equalizer according to claim 6, wherein:
first and second lights respectively have the shortest wavelength and the longest wavelength out of signal light included in wavelength division multiplexed light.

13. An optical gain equalizer according to claim 6, wherein:
the variable optical attenuator is installed on the input side of the optical fiber amplification medium.

14. An optical gain equalizer according to claim 6, wherein:
the variable optical attenuator is installed on the output side of the optical fiber amplification medium.

15. A method of equalizing the gain of wavelength division multiplexed light, comprising:
a step for selecting two lights having wavelengths mutually different out of wavelength division multiplexed light;
a step for comparing the two lights; and
a step for controlling pumping light to an optical fiber amplification medium that amplifies the wavelength division multiplexed light based upon the result of the comparison and controlling the inclination of the gain of the wavelength division multiplexed light.

16. A method of equalizing the gain of wavelength division multiplexed light, comprising:
a step for selecting two lights having wavelengths mutually different out of wavelength division multiplexed light;
a step for comparing the two lights;
a step for attenuating wavelength division multiplexed light based upon the result of the comparison; and
a step for controlling pumping light to an optical fiber amplification medium based upon the attenuated wavelength division multiplexed light and controlling the inclination of the gain of wavelength division multiplexed light.

17. A method of equalizing the gain according to claim 15, wherein:
attenuated wavelength division multiplexed light is input to an optical fiber amplification medium.

18. A method of equalizing the gain according to claim 15, wherein:
wavelength division multiplexed light amplified by an optical fiber amplification medium is attenuated.
